(19) United States
(12) Patent Application Publication
(10) Pub. No.: US 2006/0023156 A1
(43) Pub. Date: Feb. 2, 2006

(54) Liquid crystal display using slanted electric field to control inclination direction of liquid crystal molecules and method of fabricating the same

(75) Inventors: Yung-Lun Lin, Wujie Township (TW); Jenn-Jia Su, Budai Township (TW); Chih-Jen Hu, Jhongli City (TW); Ming-Chou Wu, Nantou City (TW); Po-Lun Chen, Chiayi City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/063,761

(22) Filed: Feb. 23, 2005

(30) Foreign Application Priority Data
Jul. 28, 2004 (TW) 93122629

(51) Int. Cl. G02F 1/1333

(52) U.S. Cl. 349/158

(57) ABSTRACT

A liquid crystal display (LCD) panel using a slanted electric field to control the inclination direction of liquid crystal (LC) molecules and a method of fabricating the same are disclosed. The asymmetrical bumps made of material with high dielectric constant are formed on the lower substrate, thereby improving the displaying quality of the LCD panel. After a potential difference is applied to the substrates of the LCD, a slanted electric field is generated due to the formation of asymmetrical bumps, so as to control the inclination direction of LC molecules. Also, the electrode layer could be formed over the asymmetric bumps, or formed between the asymmetric bumps and the bottom substrate.

This application claims the benefit of Taiwan application Serial No. 093122629, filed Jul. 28, 2004, the subject matter of which is incorporated herein by reference.

### BACKGROUND OF THE INVENTION

1. Field of the Invention

The invention relates in general to a liquid crystal display (LCD) using slanted electric field to control the inclination direction of liquid crystal molecules and method of fabricating the same, and more particularly to the LCD having a lower substrate on which the asymmetric bumps made of high-dielectric material are formed to generate the slanted electric field to control the inclination direction of liquid crystal molecules and method of fabricating the same.

2. Description of the Related Art

With the advantages of handy size, light weight, low power consumption and no radiation contamination, the liquid crystal displays (“LCD”) whose display effect is much superior to that of a cathode ray tube display (CRT display) has attracted the public interest in recent years. The consumers also demand the perfect images displayed on the LCD.

According to the light reflection manner, Liquid Crystal Display (LCD) can be categorized into three types: transmissive type, reflective type and transflective type. In the transmissive type LCD, the light source is provided by a backlight system, and has the advantages of good display under the environment having normal light and of the dark. However, it is difficult to clearly view the display of the transmissive type LCD under the sunlight (for example, the user want to use the LCD outdoors). In the reflective type LCD, ambient light is used as the light source (i.e. no backlight system), so that good display is presented indoors filled with light or outdoors. Also, the power consumption of the reflective type LCD is lower than that of the transmissive type LCD. The transflective type LCD, possessing the advantages of the transmissive type and reflective type LCDs, has been applied in the portable electronic products such as cellular phone and personal digital assistant (PDA).

In general, a LCD is assembled by an upper substrate and a lower substrate. The space between the upper substrate and the lower substrate is filled with numerous LC molecules. The polarization of the light passing through the liquid crystal layer is modulated by changing the alignment of the liquid crystal molecules that is varying with a voltage applied to the pixel electrode. In this way, the polarized reflected ray has the brightness corresponding to the voltage applied to the pixel electrode. When a voltage is applied to the pixel electrodes, the arrangement of the liquid crystal molecules is to be varied so that the light transmission changes. Thus, the LCD can display images with different brightness such as white, black, and intermediate gray scale. In addition, the liquid crystal molecules of the LCD can be categorized into twisted nematic (TN) mode and vertical alignment (VA) mode. When a voltage is not applied to the pixel electrodes, the TN mode liquid crystal molecules gradually twist layer by layer until the uppermost layer is at a 90° angle to the bottom layer. When a sufficient voltage is applied, the TN mode liquid crystal molecules are to be aligned and parallel to the direction of the electric field. The VA mode liquid crystal molecules, differently, are aligned and perpendicular to the upper and lower substrates when a voltage is not applied, and are twisted to be aligned and parallel to the upper and lower substrates when a sufficient voltage is applied.

For an LCD panel with a large size, such as panels used in notebook personal computers, a wide visual angle is achieved by forming multi-domains in every single pixel of the panel. FIG. 1A and FIG. 1B illustrate the arrangement of multi-domain liquid crystal molecules in vertical alignment mode of an LCD panel when a voltage is applied and not applied, respectively. The upper substrate structure 10 and the lower substrate structure 20 are assembled in parallel and the space between them is filled with liquid crystal molecules 302 so as to form a liquid crystal layer 30. The lower substrate structure 20 includes a silicon substrate 202 on which a thin film transistor (TFT), the metal layer(s) and the insulating layer(s) (those device and layers not being shown) are formed. A pixel electrode 204 is disposed above the insulating layer and is covered with an alignment film 206. As shown, each of the pixel electrodes 204 is isolated with the spacing 208, and the bottoms of the spacings 208 are covered with the alignment film 206. A protrusion 108 formed at the upper substrate is covered with the alignment film 106.

As shown in FIG. 1A, when no voltage is applied, most of the liquid crystal molecules 302 are aligned vertically to the pixel electrode 204. The liquid crystal molecules 302 adjacent to the protrusion 108 are arranged substantially vertical to the protrusion 504, and have an inclination to the pixel electrode 204. Thus, the protrusion 108 provides a pre-tilt angle for the liquid crystal molecules 302 when no voltage is applied.

As shown in FIG. 1B, when a voltage is applied, two different domains are formed on the single pixel because of the different inclinations of the molecules 302 on the left and right sides of the protrusion 108. To be more specific, the molecules adjacent to the left side of the protrusion 108 affect the left portion of the liquid crystal molecules 302 of the pixel, so that the left portion of molecules incline to the left side. Likewise, the molecules adjacent to the right side of the protrusion 108 affect the right portion of the liquid crystal molecules 302 of the pixel, resulting in the inclination of this portion of molecules to the right side. FIG. 1A and FIG. 1B show the example with only two domains in one single pixel. By changing the shape of the protrusion 108, multiple domains can be similarly implemented, leading to a wide viewing angle. However, the protrusion 108 can easily cause the problem of light leaking.

FIG. 2A illustrates a conventional VA mode LCD panel when no voltage is applied. FIG. 2B is a diagram of transmission ratio versus corresponding location on the liquid crystal layer shown in FIG. 2A. In FIG. 2A and FIG. 2B, a pixel electrode 204 and the spacings 208 on two sides thereof are illustrated for description. Since no voltage is applied, most of the liquid crystal molecules 302 are aligned and vertical to the pixel electrode 204, and the ideal transmission ratio is 0% (i.e. a straight line of 0% should be shown in FIG. 2B). However, the LC molecules adjacent to the protrusion 108 are inclined, not completely vertical to the upper substrate, and the considerable light-leaking phenomenon thus occurs in the normally black condition. In addition, an extra process is required for forming the protrusion 108, so that the production cost (including time and money) of LCD panel is increased.

FIG. 3A illustrates a conventional VA mode LCD panel when a voltage is applied. FIG. 3B is a diagram of transmission ratio versus corresponding location on the liquid crystal layer shown in FIG. 3A. For instance, the pixel electrode 204 is supplied with a voltage of +5.5 V, the liquid crystal molecules 302 would twist. In addition, the dashed lines in FIG. 3A are indicative of equipotential lines yielded after the voltage is applied to the pixel electrode 204. By drawing the pattern of the equipotential lines, the distribution of the electric field in the liquid crystal molecules 302 can be determined. The result of FIG. 3B indicates that the transmission ratio (point a) corresponding to the position of protrusion 108 is 0%, while the transmission ratios (point a) corresponding to the other position of pixel electrode 204 are unsteady (i.e. points b and c are slightly lower). Also, the distribution of the electric field near the edges of the pixel electrode 204 is irregular, resulting in the liquid crystal molecules 308 twisting in irregular directions. The transmission ratios corresponding to the positions near the edges of the pixel electrode 204 undesirably decreased (i.e. the curving sections before point d and after point e). Therefore, the undesired small gray areas occur on the edges of pixel electrode 204, so as to degrade the display quality of the pixels.

### SUMMARY OF THE INVENTION

It is therefore an object of the invention to provide a liquid crystal display (LCD) using slanted electric field to control the inclination direction of liquid crystal molecules and method of fabricating the same. Several asymmetric bumps made of high-dielectric material on the lower substrate of LCD panel are formed, and each bump is composed of surfaces with different curvatures or slopes. When the voltage is applied on those asymmetric bumps, a slanted electric field is generated to control the inclination direction of liquid crystal molecules so as to solve the problem of light leaking.

The invention achieves the objects by providing a liquid crystal display (LCD) panel comprising an upper substrate structure, a lower substrate structure and a liquid crystal layer. The lower substrate structure has a lower substrate and several asymmetric bumps with high dielectric constant formed above the lower substrate. In the liquid crystal layer, there are numerous liquid crystal molecules filling between the upper substrate structure and the lower substrate structure. When a voltage is applied on the LCD panel, a slanted electric field is generated to control inclination direction of the liquid crystal molecules.

The invention achieves the objects by providing a method of fabricating lower substrate structure of LCD panel. The lower substrate structure is assembled with an upper substrate structure to form the LCD panel, and numerous liquid crystal molecules fill between the upper substrate structure and the lower substrate structure. The method comprises the steps of:
providing a lower substrate;
forming a high-dielectric layer on the lower substrate; and
patterning the high-dielectric layer to form a plurality of asymmetric bumps with high dielectric constant.

Also, an electrode layer could be formed over the asymmetric bumps, or formed between the asymmetric bumps and the bottom substrate.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A and FIG. 1B (prior art) illustrate the arrangement of multi-domain liquid crystal molecules in vertical alignment mode of an LCD panel when a voltage is applied and not applied, respectively.

FIG. 2A (prior art) illustrates a conventional VA mode LCD panel when no voltage is applied.

FIG. 2B (prior art) is a diagram of transmission ratio versus corresponding location on the liquid crystal layer shown in FIG. 2A.

FIG. 3A (prior art) illustrates a conventional VA mode LCD panel when a voltage is applied.

FIG. 3B (prior art) is a diagram of transmission ratio versus corresponding location on the liquid crystal layer shown in FIG. 3A.

FIG. 4 illustrates a bump structure formed on the lower substrate according to the preferred embodiment of the invention.

FIG. 5A illustrates the tilt direction of the liquid crystal molecules in a single pixel of LCD panel according to an embodiment of the invention.

FIG. 5B illustrates the tilt directions of the liquid crystal molecules in a single pixel of LCD panel according to another embodiment of the invention.

FIG. 6A˜FIG. 6D are the cross-sectional views showing a method of fabricating the bump structure on the lower substrate according to the first embodiment of the invention.

FIG. 7A˜FIG. 7D are the cross-sectional views showing a method of fabricating the bump structure on the lower substrate according to the second embodiment of the invention.

FIG. 8A illustrates the alignment of VA mode liquid crystal molecules in LCD panel according to the simulation 1 of the invention.

FIG. 8B is a diagram of transmission ratio versus corresponding location on the liquid crystal layer shown in FIG. 8A.

FIG. 9A illustrates the alignment of VA mode liquid crystal molecules in LCD panel according to the simulation 2 of the invention.

FIG. 9B is a diagram of transmission ratio versus corresponding location on the liquid crystal layer shown in FIG. 9A.

FIG. 10A illustrates the alignment of VA mode liquid crystal molecules in LCD panel according to the simulation 3 of the invention.

FIG. 10B is a diagram of transmission ratio versus corresponding location on the liquid crystal layer shown in FIG. 10A.

FIG. 11A illustrates the alignment of VA mode liquid crystal molecules in LCD panel according to the simulation 4 of the invention.

FIG. 11B is a diagram of transmission ratio versus corresponding location on the liquid crystal layer shown in FIG. 11A.

FIG. 12A illustrates the alignment of VA mode liquid crystal molecules in LCD panel according to the simulation 5 of the invention.

FIG. 12B is a diagram of transmission ratio versus corresponding location on the liquid crystal layer shown in FIG. 12A.

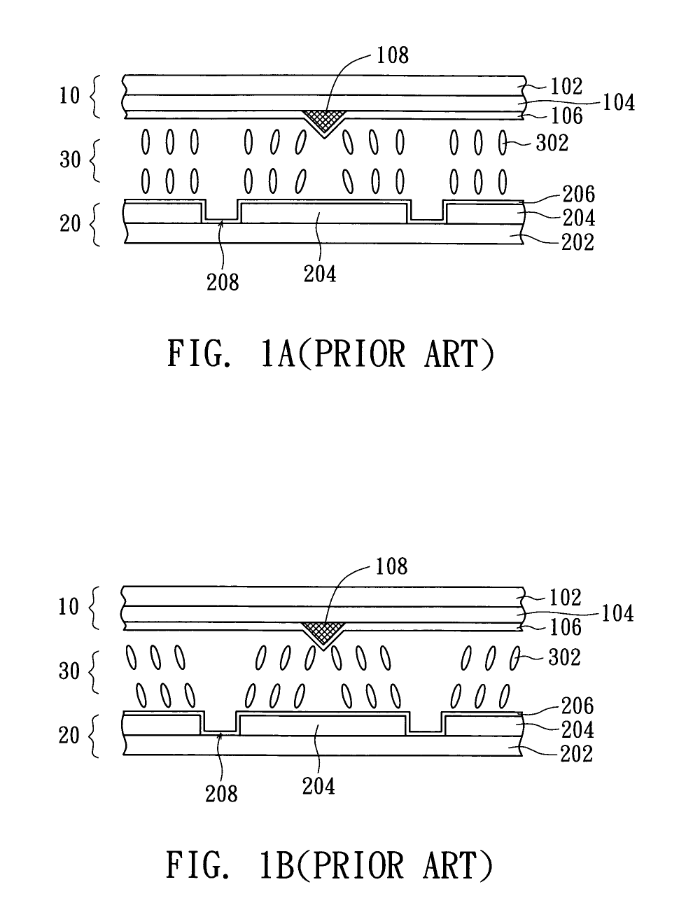

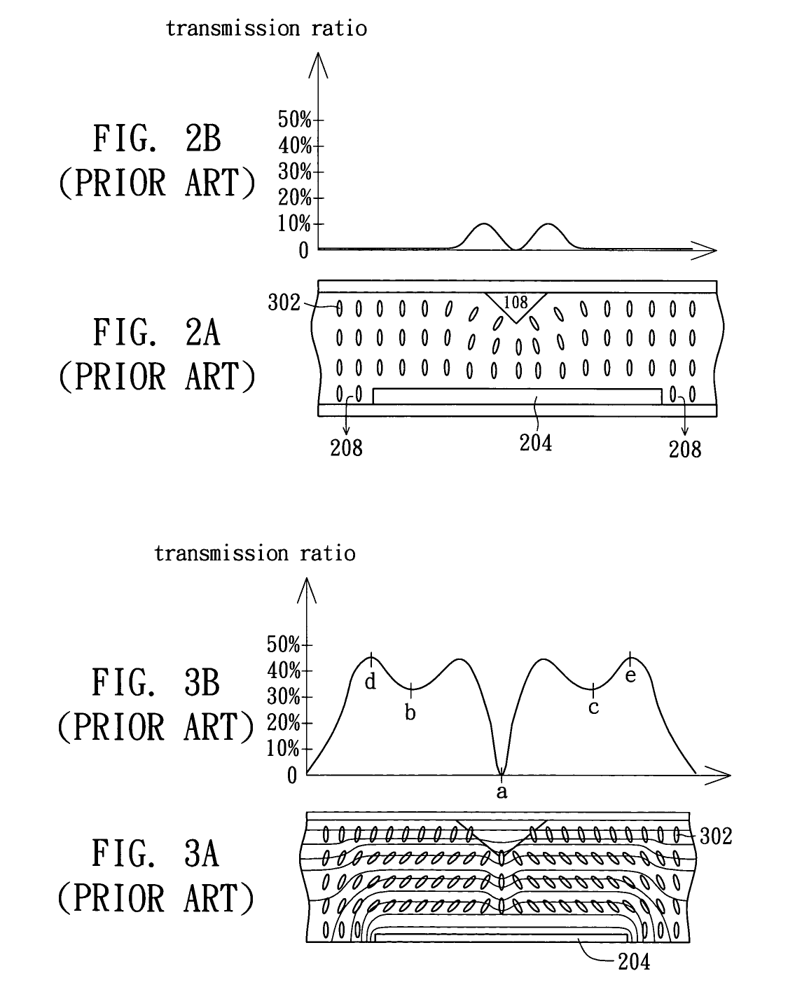

### DETAILED DESCRIPTION OF THE INVENTION

The invention provides a liquid crystal display (LCD) using slanted electric field to control the inclination direction of liquid crystal molecules and method of fabricating the same. By forming several bumps made of high-dielectric material on the lower substrate of LCD panel and each bump has an asymmetric surface (i.e. each bump is composed of the parts having the curved surfaces with the different curvatures or the slanted surfaces with the different slopes), the slanted electric field is generated to control the inclination direction of liquid crystal molecules when the voltage is applied on those symmetric bumps, so as to solve the problem of light leaking.

The embodiment disclosed herein is for illustrating the invention, but not for limiting the scope of the invention. Additionally, the drawings used for illustrating the embodiment of the invention only show the major characteristic parts in order to avoid obscuring the invention. Accordingly, the specification and the drawing are to be regard as an illustrative sense rather than a restrictive sense.

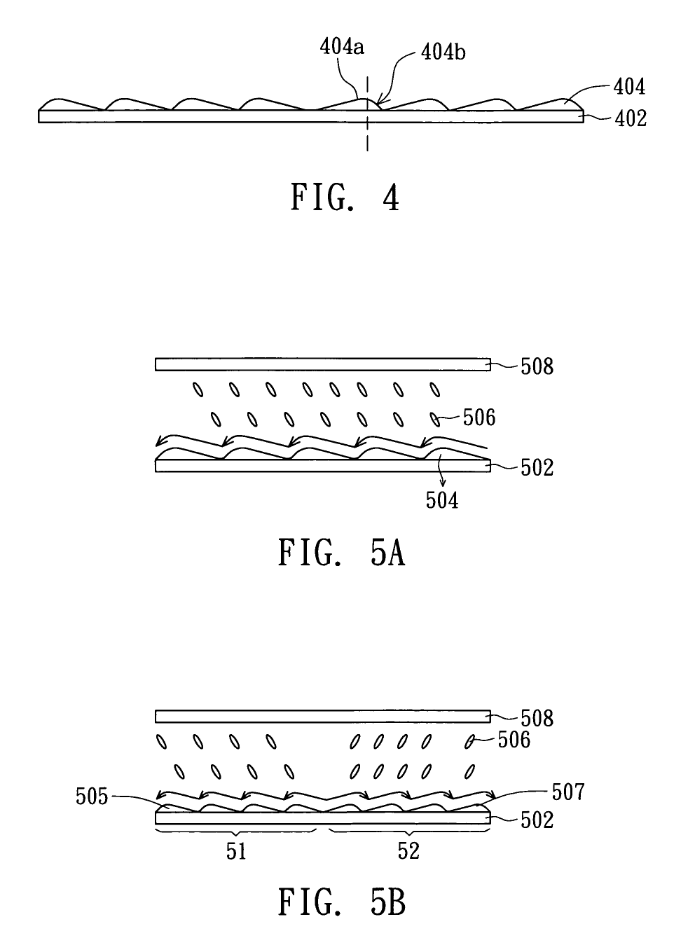

FIG. 4 illustrates a bump structure formed on the lower substrate according to the preferred embodiment of the invention. Those asymmetric bumps 404 are made of high-dielectric material, and each bump is composed of the parts having the curved surfaces with the different curvatures (such as circular arcs or elliptic arcs), or the parts having the slanted surfaces with the different slopes (such as the configuration of the serrate bumps on the lower substrate 402). The method of fabricating these bumps is described later. As shown in FIG. 4, the left arc 404a and the right arc 404b, which have the different curvatures, composes an asymmetric bump 404. When an electrode is coated over or beneath these asymmetric and high dielectric bumps 404, a slanted electric field is generated to control the inclination direction of liquid crystal molecules after the voltage is applied. In addition, those asymmetric bumps 404 can be regularly or randomly formed on the lower substrate, the invention is not limited herein. The arrangement of the bumps can be optionally varied as long as the generation of slanted electric field can be achieved.

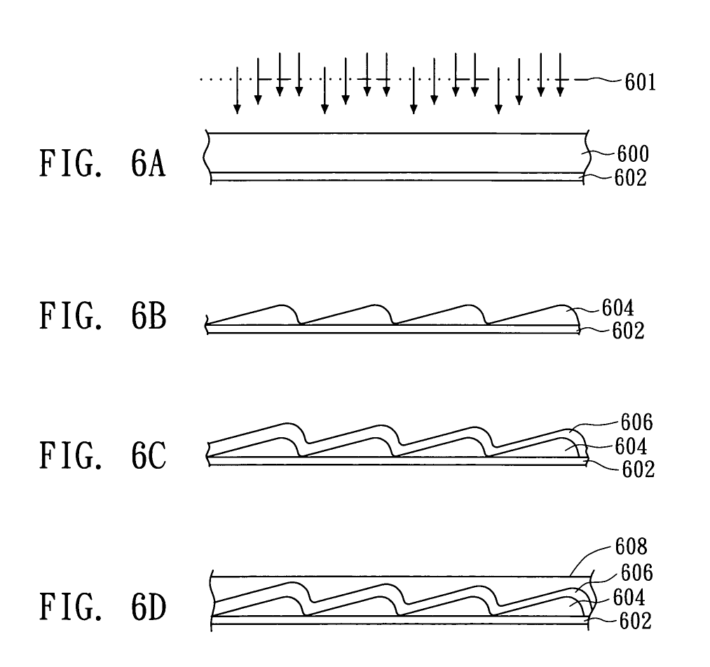

FIG. 5A illustrates the tilt direction of the liquid crystal molecules in a single pixel of LCD panel according to an embodiment of the invention. FIG. 5B illustrates the tilt directions of the liquid crystal molecules in a single pixel of LCD panel according to another embodiment of the invention.

As shown in FIG. 5A, several bumps 504, same size or not, are formed on the lower substrate 502 of a single pixel. Each bump 504 has a left inclined surface and a right inclined surface, and the slope of the left inclined surface is greater than that of the right inclined surface. Accordingly, the electric field with only one slanted direction (represented by the arrows) is generated when the voltage is applied on the pixel electrode, so as to control all of the liquid crystal molecules to incline leftward.

As shown in FIG. 5B, two groups of bump structures 51, 52 are formed on the lower substrate 502 of a single pixel, to generate two electric fields with different directions. The asymmetric bump 505 of the group of bump structure 51 is composed of a first slanted surface and a second slanted surface, and a first tilt angle of the first slanted surface is different from a second tilt angle of the second slanted surface (i.e. the tilt angle of the left slanted surface is smaller than that of the right slanted surface). Thus, when the voltage is applied on the pixel electrode, an electric field with left slanted direction (represented by the arrows at the left side) is generated by the group of bump structure 51, so as to control the liquid crystal molecules above the bumps 505 to incline leftward. Similarly, when the voltage is applied on the pixel electrode, an electric field with right slanted direction (represented by the arrows at the right side) is generated by the group of bump structure 52, and the liquid crystal molecules above the bumps 507 are inclined rightward.

Although the same numbers of bumps in two groups of bump structure are taken for illustration in FIG. 5B (i.e. each group has 4 bumps), the invention is not limited herein. Several groups of bump structures can be formed on the lower substrate of a single pixel, and the numbers of bumps in different groups can be the same or not. It is also acceptable to randomly form the asymmetric bumps on the lower substrate. The bumps can be the same size or not.

Moreover, the experimental results according to the embodiments of the invention have indicated that most of the liquid crystal molecules are aligned vertically when no voltage is applied on the pixel electrode, and the liquid crystal molecules adjacent to the boundary between two bumps are tilted only to a very small extent so that no considerable light leaking occurs. The experimental results also indicated that the slanted electric field restricts the tilt direction of the liquid crystal molecules and the liquid crystal molecules tilt instantly when voltage is applied on the pixel electrode. Accordingly, the bump structure of the invention clearly defines the tilt direction of the liquid crystal molecules, and multiple domains can be implemented by adequately arranging the groups of the bump structures, leading to a wide viewing angle.

It is noted that the bump structure formed on the lower substrate of the LCD panel according to the invention provides a slanted electric field for making the liquid crystal molecules incline instantly when voltage is applied on the pixel electrode, and the conventional protrusion formed on the upper substrate is not the essential component of the LCD panel. Also, the bump structure of the invention does effectively eliminate the light-leaking defect when no voltage is applied on the pixel electrode.

Two embodiments are taken for describing the methods of fabricating the bump structures of the invention, wherein the slanted electric field(s) is(are) generated by the asymmetric bumps of the bump structure(s).

### First Embodiment

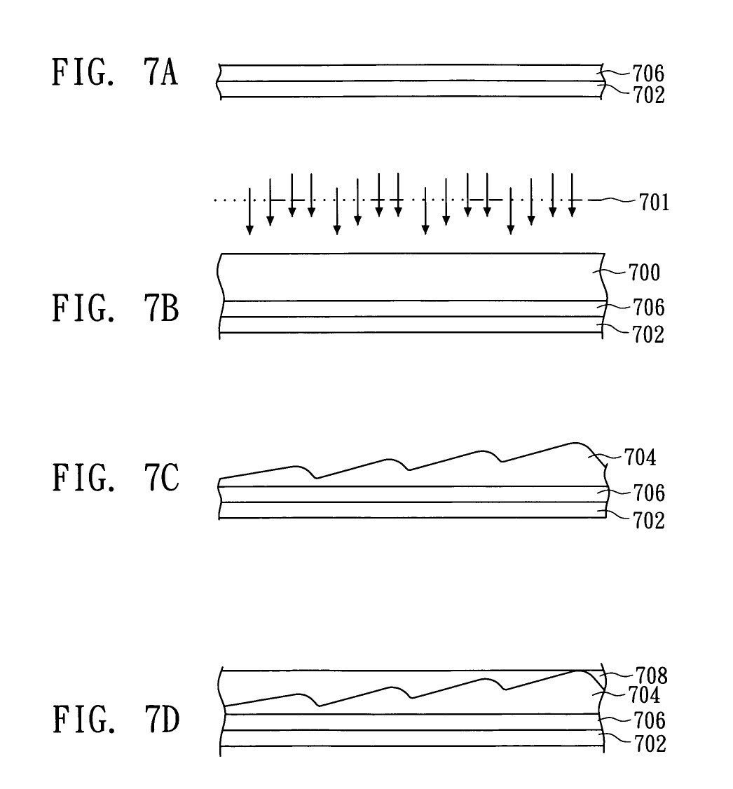

FIG. 6A˜FIG. 6D are the cross-sectional views showing a method of fabricating the bump structure on the lower substrate according to the first embodiment of the invention. First, a lower substrate 602 is provided, and a high-dielectric layer (such as high-dielectric organic layer) 600 is formed on the lower substrate 602, as shown in FIG. 6A. The high-dielectric layer 600 is made of the material having the high dielectric constant, for example, silicon nitride having the dielectric constant of 6.7˜7.0. Then, a photo-mask 601 (such as a gray level photo-mask) is provided for patterning the high-dielectric layer 600 by exposure and developing. After pattern transforming step, several asymmetric bumps 604 made of high-dielectric material are formed on the lower substrate 602, as shown in FIG. 6B.

The high-dielectric layer 600 can be patterned by the irradiation with UV light through the pattern of the gray level photo-mask 601, or patterned by a step-index type photolithography. The step-index type photolithography, using a photo-mask with single slit and performance of multi-step exposure, can be applied for patterning the high-dielectric layer 600. For example, the high-dielectric layer 600 is exposed to the UV (Ultraviolet) light at intensity of L₁ for time t₁ first, and an exposed area A is formed. Next, the photo-mask is shifted and the photo-resist is exposed under the UV light at intensity of L₂ for time t₂, to form an exposed area B. Then, shift the photo-mask and perform the exposure, as depicted before. Those steps are repeated. Either by setting equal exposing time and the light intensity L₁>L₂> . . . , or by setting equal intensity and the exposing time t₁>t₂> . . . , the size of exposing areas are controlled at the order of A>B> . . . Subsequently, the high-dielectric layer 600 is developed to form a ladder-like look, and then re-flowed by heating to form the bumps 604.

Next, an electrode layer 606 is formed over the asymmetric bumps 604 made of high-dielectric material, as shown in FIG. 6C. For a transmissive type LCD panel, a transparent electrode such as the electrode made of indium tin oxide (ITO) or indium zinc oxide (IZO) can be used as the electrode layer 606. For a reflective type and a transflective type LCD panels, the metal having good reflective property (such as aluminum) is suitable for being the electrode layer 606.

Afterward, a transparent low-dielectric layer 608 is formed over the electrode layer 606, for the purpose of planarization, as shown in FIG. 6D. The alignment film (not shown in FIG. 6D) could be formed on the low-dielectric layer 608, or between the electrode layer 606 and the low-dielectric layer 608. The lower substrate structure also comprises the thin film transistor (TFT), the other chemical layers and electric components (not shown).

After forming the lower substrate structure having the asymmetric bumps (as shown in FIG. 6D), the lower substrate structure is assembled with the upper substrate structure, and the space there between is filled with the liquid crystal molecules. The upper substrate structure comprises the color filter (CF) and the upper substrate having an electrode layer. Also, the bump structure formed on the lower substrate of the LCD panel according to the invention provide a slanted electric field for making the liquid crystal molecules incline instantly when voltage is applied on the pixel electrode, without forming the conventional protrusion on the upper substrate.

### Second Embodiment

FIG. 7A˜FIG. 7D are the cross-sectional views showing a method of fabricating the bump structure on the lower substrate according to the second embodiment of the invention. The major difference of the lower substrate structure between the first embodiment and the second embodiment is the disposing position of the electrode layer.

First, a lower substrate 702 is provided, and an electrode layer 706 is formed on the lower substrate 702, as shown in FIG. 7A. The material of the electrode layer 706 could be indium tin oxide (ITO), indium zinc oxide (IZO) (for a transmissive type LCD panel), or metals having good reflective property such as aluminum (for a reflective type and a transflective type LCD panels).

Second, a high-dielectric layer (such as high-dielectric organic layer) 700 is formed on the electrode layer 706, as shown in FIG. 7A. Then, a photo-mask 701 (such as a gray level photo-mask) is provided for patterning the high-dielectric layer 700 by exposure and developing, as shown in FIG. 7B. Also, the high-dielectric layer 700 can be patterned by the irradiation with UV light through the pattern of the gray level photo-mask 701, or patterned by a step-index type photolithography as described in the first embodiment.

After pattern transforming step, several asymmetric bumps 704 made of high-dielectric material are formed on the electrode layer 706, as shown in FIG. 7C. Then, a transparent low-dielectric layer 708 is formed over the asymmetric bumps 704, for the purpose of planarization, as shown in FIG. 7D.

The lower substrate structure having the asymmetric bumps (as shown in FIG. 7D) is then assembled an upper substrate structure, and the space therebetween is filled with the liquid crystal molecules. The upper substrate structure comprises the color filter (CF) and the upper substrate having an electrode layer. Also, the bump structure formed on the lower substrate of the LCD panel according to the invention provides a slanted electric field for making the liquid crystal molecules incline instantly when voltage is applied on the pixel electrode, without forming the conventional protrusion on the upper substrate.

No matter where the electrode layer is (above the bumps as illustrated in the first embodiment, or beneath the bumps as illustrated in the second embodiment), a slanted electric field can be generated to incline the liquid crystal molecules instantly when the voltage is applied on the pixel electrode. Moreover, by using two methods described in the first and the second embodiments, the asymmetric bumps of the same size (the bumps having the same height in the first embodiment) or not (the bumps having the increasing heights in the second embodiment) can be obtained, depending on the photolithography conditions of the practical applications.

In the following description, the effect of bump structures according to the invention on the liquid crystal molecules is simulated by 2-D mos program, and whether the light-leaking defect occurs is observed.

Moreover, in the simulating experimentation, the gap between the upper substrate and the lower substrate ranges from 2 μm to 6 μm, and the average height of the bumps ranges from 0.48 μm±0.72 μm.

Simulation 1

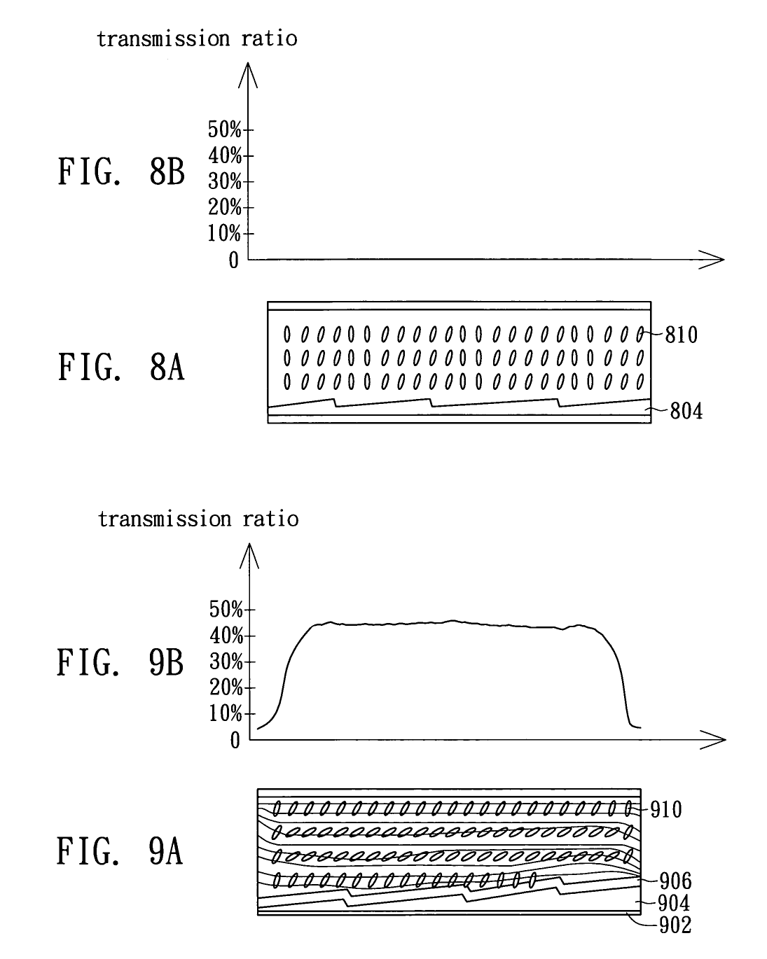

FIG. 8A illustrates the alignment of VA mode liquid crystal molecules in LCD panel according to the simulation 1 of the invention. FIG. 8B is a diagram of transmission ratio versus corresponding location on the liquid crystal layer shown in FIG. 8A. The lower substrate having the bump structure in a pixel size according to the second embodiment (as shown in FIG. 7C) is applied in simulation 1.

The result indicated that the liquid crystal molecules aligned at the joints of the asymmetric bumps 804 having saw-tooth configuration are only slightly inclined when no voltage is applied, and this small extent of inclination causes no light-leaking defect. Thus, the LCD panel has a transmission ratio of 0% when no voltage is applied.

Simulation 2

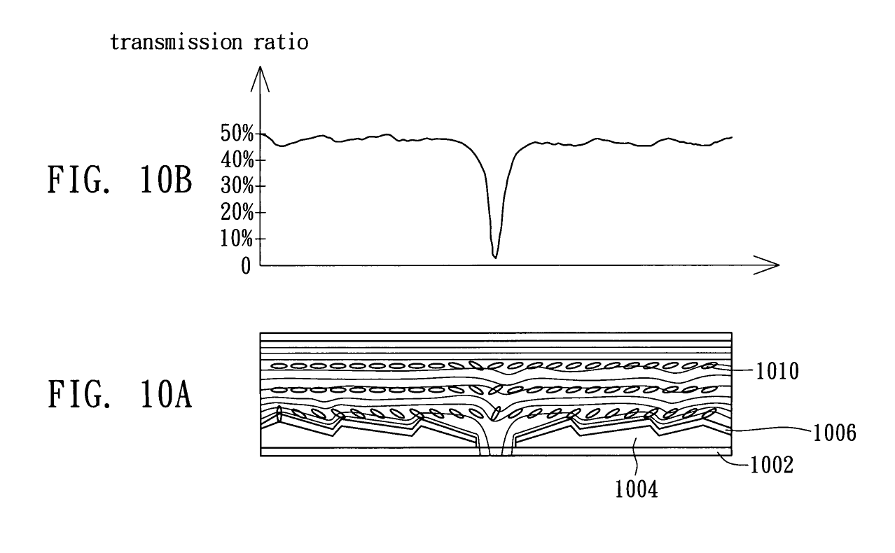

FIG. 9A illustrates the alignment of VA mode liquid crystal molecules in LCD panel according to the simulation 2 of the invention. FIG. 9B is a diagram of transmission ratio versus corresponding location on the liquid crystal layer shown in FIG. 9A.

The lower substrate having the bump structure in a pixel size according to the first embodiment is applied in simulation 2. The bumps 904 on the lower substrate 902 having the increasing heights are arranged in a pixel, and an electrode layer 906 is formed on the bumps 904.

The result indicated that the liquid crystal molecules 910 are instantly inclined within 15.00 ms and oriented along the electric field when a voltage of 5.5 V is applied on the electrode layer 906. The dashed lines in FIG. 9A are indicative of equipotential lines yielded after the voltage is applied to the electrode layer 906. The pattern of the equipotential lines shows the electric field and determines the distribution (i.e. the inclined direction) of the liquid crystal molecules.

Simulation 3

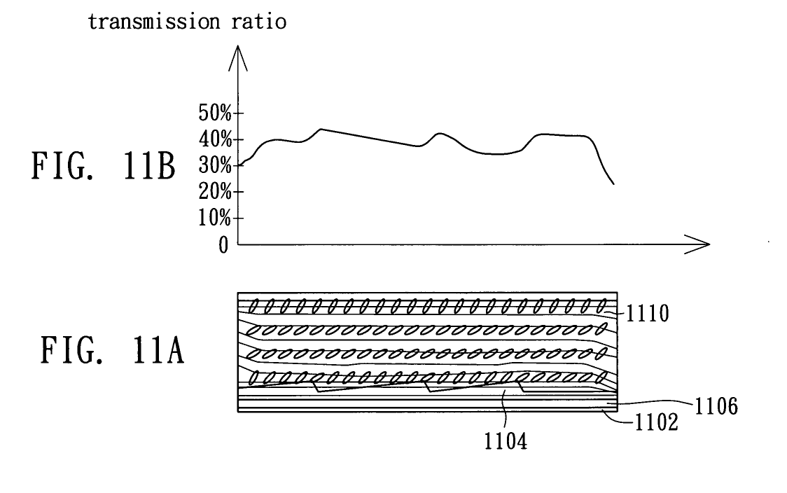

FIG. 10A illustrates the alignment of VA mode liquid crystal molecules in LCD panel according to the simulation 3 of the invention. FIG. 10B is a diagram of transmission ratio versus corresponding location on the liquid crystal layer shown in FIG. 10A.

The lower substrate having the bump structure according to the first embodiment is also applied in simulation 3. The spacing between the adjacent pixels is considered for observing the alignment of the liquid crystal molecules above and closed to the spacing. The bumps 1004 on the lower substrate 1002 having the same height are arranged in a pixel, and an electrode layer 1006 is formed on the bumps 1004. Also, after a voltage is applied, the opposite electric fields (the dashed lines in FIG. 10A) are generated for the bump groups at the right and left sides.

The result indicated that the liquid crystal molecules 1010 are instantly inclined within 15.00 ms and oriented along the electric field when a voltage of 5.5 V is applied on the electrode layer 1006. Compared to the conventional LCD panel (see FIG. 3B), the LCD panel having the bump structure according to simulation 3 can reduce the fringe effect, and the transmission ratio of a pixel is substantially a stable value after a voltage is supplied.

Simulation 4

FIG. 11A illustrates the alignment of VA mode liquid crystal molecules in LCD panel according to the simulation 4 of the invention. FIG. 11B is a diagram of transmission ratio versus corresponding location on the liquid crystal layer shown in FIG. 11A.

The lower substrate having the bump structure in a pixel size according to the second embodiment is applied in simulation 4. The electrode layer 1106 is formed on the lower substrate 1102 first, and then the bumps 1104 having the same size are formed on the electrode layer 1106.

The result indicated that the liquid crystal molecules 1110 are instantly inclined within 15.00 ms and oriented along the electric field when a voltage of 5.5 V is applied. Also, the transmission ratio of a pixel is substantially stable. The decline of the transmission curve (i.e. the right end of the curve) is predictably occurred due to the absence of the bump correspondingly formed on the lower substrate 1102.

Simulation 5

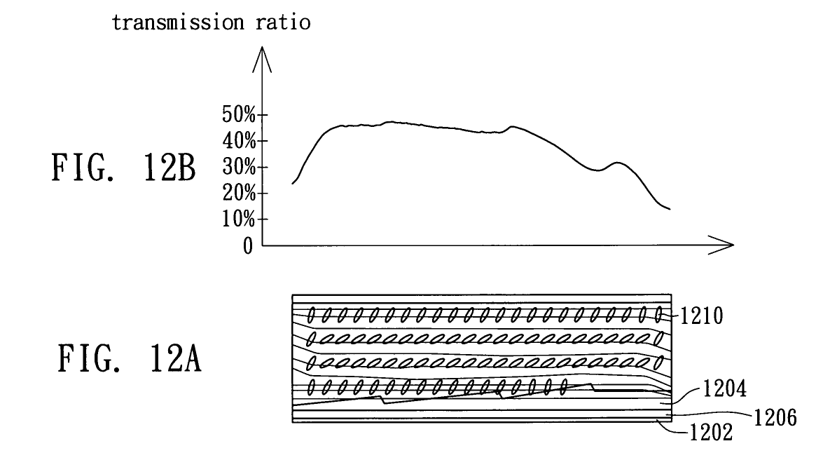

FIG. 12A illustrates the alignment of VA mode liquid crystal molecules in LCD panel according to the simulation 5 of the invention. FIG. 12B is a diagram of transmission ratio versus corresponding location on the liquid crystal layer shown in FIG. 12A.

The lower substrate having the bump structure in a pixel size according to the second embodiment is applied in simulation 5. The electrode layer 1206 is formed on the lower substrate 1202 first, and then the bumps 1204 having the increasing heights are formed on the electrode layer 1206.

The result indicated that the liquid crystal molecules 1210 are instantly inclined within 15.00 ms and oriented along the electric field when a voltage of 5.5 V is applied. Also, the transmission ratio of a pixel is substantially stable. Similar to the result of simulation 4, the decline of the transmission curve (i.e. the right end of the curve) is caused by the absence of the bump correspondingly formed on the lower substrate 1202.

Accordingly, the results of simulations 1˜5 have proved that the application of the asymmetric bumps on the lower substrate according to the embodiments of the invention have the advantages including elimination of the light-leaking drawback when no voltage is supplied to the pixel electrode and instant inclination of liquid crystal molecules when a voltage is supplied, leading to a wide viewing angle for a LCD panel in the application.

Moreover, it is, of course, understood by people skilled in the art that the bump configuration is not limited in the illustration of the embodiments. Any asymmetric bump composed of the parts having the slanted surfaces with the different slopes or the curved surfaces with the different curvatures can be used for generating a slanted electric field to control the inclination direction of liquid crystal molecules after the voltage is applied.

While the invention has been described by way of examples and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A liquid crystal display (LCD) panel, comprising:
an upper substrate structure;
a lower substrate structure having a lower substrate and a plurality of asymmetric bumps with high dielectric constant formed above the lower substrate; and
a liquid crystal layer disposed between the upper substrate structure and the lower substrate structure.

2. The LCD panel according to claim 1, wherein each asymmetric bump is composed of parts having curved surfaces with different curvatures.

3. The LCD panel according to claim 1, wherein each asymmetric bump is composed of parts having slanted surfaces with different slopes.

4. The LCD panel according to claim 1, wherein each asymmetric bump has a first curved surface and a second curved surface, and a first inclined angle of the first curved surface is smaller than a second inclined angle of the second curved surface.

5. The LCD panel according to claim 1, wherein each asymmetric bump has a left curved surface and a right curved surface, and a left curvature of the left curved surface is different from a right curvature of the right curved surface.

6. The LCD panel according to claim 1, wherein a gap between the upper substrate structure and the lower substrate structure ranges from about 2 μm to about 6 μm, and an average height of the asymmetric bumps ranges from about 0.48 μm to about 0.72 μm.

7. The LCD panel according to claim 1, further comprising an electrode layer formed on the asymmetric bumps.

8. The LCD panel according to claim 7, wherein the electrode layer comprises a transparent electrode.

9. The LCD panel according to claim 7, wherein the electrode layer comprises a reflective electrode.

10. The LCD panel according to claim 7, further comprising a transparent layer having low dielectric constant formed on the electrode layer for planarization.

11. The LCD panel according to claim 1, further comprising an electrode layer formed between the lower substrate and the asymmetric bumps.

12. The LCD panel according to claim 11, wherein the electrode layer comprises a transparent electrode.

13. The LCD panel according to claim 11, wherein the electrode layer comprises a reflective electrode.

14. The LCD panel according to claim 11, further comprising a transparent layer having low dielectric constant formed on the electrode layer for planarization.

15. The LCD panel according to claim 1, wherein the asymmetric bumps are made of silicon nitride.

16. The LCD panel according to claim 15, wherein a dielectric constant of the asymmetric bumps ranges from about 6.7 to 7.0.

17. A method of fabricating lower substrate structure for LCD panels, comprising the steps of:
providing a lower substrate;
forming a high-dielectric layer on the lower substrate; and
patterning the high-dielectric layer to form a plurality of asymmetric bumps with high dielectric constant.

18. The method according to claim 17, wherein each asymmetric bump has a left curved surface and a right curved surface, and a left curvature of the left curved surface is different from a right curvature of the right curved surface.

19. The method according to claim 17, wherein each asymmetric bump has a first curved surface and a second curved surface, and a first inclined angle of the first curved surface is smaller than a second inclined angle of the second curved surface.

20. The method according to claim 17, further comprising the step of forming an electrode layer on the asymmetric bumps.

21. The method according to claim 20, further comprising the step of forming a transparent layer with a low dielectric constant on the electrode layer for planarization.

22. The method according to claim 17, further comprising the step of forming an electrode layer between the lower substrate and the asymmetric needed to d bumps.

23. The method according to claim 22, further comprising the step of forming a transparent layer having low dielectric constant on the electrode layer for planarization.

24. The method according to claim 17, wherein the step of patterning the high-dielectric layer is performed by exposure and developing processes using a gray level photo-mask.

25. The method according to claim 17, wherein the step of patterning the high-dielectric layer is performed by step-index type photolithography.

26. The method according to claim 17, wherein the asymmetric bumps are made of silicon nitride.

27. The method according to claim 17, wherein a dielectric constant of the asymmetric bumps ranges from about 6.7 to 7.0.
